(19) United States
(12) Patent Application Publication
(10) Pub. No.: US 2022/0382254 A1
(43) Pub. Date: Dec. 1, 2022

(54) PRODUCTION CONTROL SYSTEM FOR VEHICLE AND METHOD THEREOF

(71) Applicant: TEIA Co., Ltd., Anyang-si (KR)

(72) Inventors: CHOONJAE LEE, Seoul (KR); BYEONGHEE YOUN, Yongin-si (KR); JUNHO OH, Incheon (KR)

(73) Assignee: TEIA Co., Ltd., Anyang-si (KR)

(21) Appl. No.: 17/750,439

(22) Filed: May 23, 2022

(30) Foreign Application Priority Data
May 26, 2021 (KR) 10-2021-0067881

(51) Int. Cl. G05B 19/418; G06K 7/10

(52) U.S. Cl. CPC G05B 19/4183; G05B 19/4185; G06K 7/10316

(57) ABSTRACT

A production control system includes: a plurality of tag devices each attached to a corresponding one of a plurality of vehicles each having an identification code and moving along a production line together with the plurality of vehicles to identify positions of the plurality of vehicles, the plurality of tag devices each having a tag ID; a tag reader disposed on the production line and configured to recognize the tag ID of the tag device; a code reader disposed on the production line and configured to recognize the identification code of the vehicle; and a server configured to receive the identification code of the vehicle from the code reader and receive the tag ID of the tag device from the tag reader and map the identification code and the tag ID.

### CROSS-REFERENCE TO RELATED APPLICATION

This application claims priority to and the benefit of Korean Patent Application No. 10-2021-0067881, filed on May 26, 2021, the disclosure of which is incorporated herein by reference in its entirety.

### BACKGROUND

### 1. Field of the Invention

The present invention relates to a production control system for a vehicle and a method thereof.

### 2. Discussion of Related Art

Generally, in a production line of a vehicle manufacturing factory, a vehicle assembly process is managed by attaching electronic tags attached to respective vehicles transported by a conveyor.

The electronic tag has a benefit of enabling a vehicle to be identified in a non-contact way through a tag ID transmitted as a wireless signal, and due to the benefit, many manufacturing processes on recently automated production lines are employing a tag ID recognition-based process, and research thereon is ongoing. Such a tag ID recognition-based process operates on the assumption that the electronic tag is normally attached to the vehicle and normally operates.

However, it is difficult to rule out the possibility that the electronic tag is detached from the vehicle or does not operate normally due to various reasons, such as external shocks, environment, and the like, in which case, an error in tag ID recognition occurs or the recognition is not performed.

For example, on a production line of a vehicle factory, different optional parts may be installed in vehicles, but when the tag ID of the vehicle is misrecognized or unrecognized, parts may be incorrectly installed or not installed, leading to product defects.

In addition, when normal tag ID recognition is not possible, confusion in the production may occur, and there is a problem of the yield of the production line being lowered due to line stoppage.

The details disclosed in this background section is only for enhancement of understanding of the background of the invention and it may therefore contain details that are not a part of the related art that is already known to a person of ordinary skill in the art.

### SUMMARY OF THE INVENTION

The present invention is directed to providing a production control system for a vehicle and a method thereof capable of preventing a production delay due to a defect or non-attachment of a tag. The scope of the present invention is not limited thereto.

The technical objectives of the present invention are not limited to the above, and other objectives may become apparent to those of ordinary skill in the art based on the following description.

According to an aspect of the present invention, there is provided a production control system for a vehicle, including: a plurality of tag devices each attached to a corresponding one of a plurality of vehicles each having an identification code and moving along a production line together with the plurality of vehicles to identify positions of the plurality of vehicles, the plurality of tag devices each having a tag ID; a tag reader disposed on the production line and configured to recognize the tag ID of the tag device; a code reader disposed on the production line and configured to recognize the identification code of the vehicle; and a server configured to receive the identification code of the vehicle from the code reader and receive the tag ID of the tag device from the tag reader and map the identification code and the tag ID, and upon a failure to map the identification code to the tag ID for a predetermined reason, generate a virtual tag having a virtual ID, map the virtual ID and the identification code, and track the virtual tag.

The server may be configured to, upon consecutively receiving the identification codes but non-consecutively receiving the tag IDs, generate the virtual tag having the virtual ID corresponding to an identification code present before the mapped identification code and map the generated virtual tag and the identification code.

According to another aspect of the present invention, there is provided a production control system for a vehicle, including: a plurality of tag devices each attached to a corresponding one of a plurality of vehicles each having an identification code and moving along a production line together with the plurality of vehicles to identify positions of the plurality of vehicles, the plurality of tag devices each having a tag ID; a first tag reader disposed on the production line and configured to recognize the tag ID of the tag device; a second tag reader disposed on the production line and configured to recognize the tag ID of the tag device that has been recognized by the first tag reader; a code reader disposed on the production line and configured to recognize the identification code of the vehicle recognized by the first tag reader; and a server configured to receive the identification code of the vehicle from the code reader and receive the tag ID of the tag device from the first tag reader and map the identification code and the tag ID, and upon occurrence of a misrecognition of the mapped tag device in the second tag reader, generate a virtual tag corresponding to the tag ID or the identification code and track the virtual tag.

The server may be configured to determine a case of a preceding tag device being recognized by the second tag reader but a following tag device not being recognized within a predetermined time or poorly recognized by the second tag reader as a misrecognition.

The server may be configured to track the virtual tag based on a position of the tag device adjacent to the virtual tag.

The server may be configured to display positions of the tag device and the virtual tag.

According to another aspect of the present invention, there is provided a production control method of controlling the production control system for the vehicle according to claim 1, the production control method including: a reception operation of receiving the tag ID and the identification code; a mapping operation of mapping the tag ID and the identification code; a virtual tag generation operation of generating, upon a mapping failure, a virtual tag having a virtual ID corresponding to an identification code for which the mapping has failed; a virtual mapping operation of mapping the identification code, for which the mapping has failed, and the virtual ID; and a virtual tracking operation of tracking the virtual tag.

The mapping operation may include, upon consecutively receiving the identification codes but non-consecutively receiving the tag IDs corresponding to the identification codes, determining an identification code corresponding to a missing tag ID as a mapping failure.

According to another aspect of the present invention, there is provides a production control method of controlling the production control system for the vehicle according to claim 3, the production control method including: a tag ID receiving operation of receiving, by the second tag reader, a tag ID of the tag device; generating, upon a misrecognition or non-recognition in the tag ID reception operation, the virtual tag corresponding to the tag ID or the identification code; and tracking the virtual tag.

The production control method may further include determining a case of a tag ID of a preceding tag device being received from the second tag reader but a tag ID of a following tag device not being received within a predetermined time or erroneously received as a non-recognition or a misrecognition.

Other aspects, features, and advantages that are not described above will become apparent to those of ordinary skill in the art with reference to detailed description of the following embodiments in conjunction with the scope of claims and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram schematically illustrating a production control system for a vehicle according to an embodiment of the present invention;

FIG. 2 is a block diagram schematically illustrating a tag device of a production control system for a vehicle according to an embodiment of the present invention;

FIG. 3 is a block diagram schematically illustrating a server of a production control system for a vehicle according to an embodiment of the present invention;

FIG. 4 is a flowchart schematically showing a production control method for a vehicle according to an embodiment of the present invention;

FIG. 5 shows diagrams schematically showing a production control method for a vehicle according to an embodiment of the present invention;

FIG. 6 is a conceptual diagram schematically illustrating a production control system for a vehicle according to another embodiment of the present invention;

FIG. 7 is a block diagram schematically illustrating a tag device of a production control system for a vehicle according to another embodiment of the present invention; and

FIG. 8 shows diagrams schematically showing a production control method for a vehicle according to another embodiment of the present invention.

### DETAILED DESCRIPTION OF EXEMPLARY EMBODIMENTS

Hereinafter, various embodiments of the present invention will be described in detail with reference to the accompanying drawings. Since the embodiments according to the concept of the present invention are subject to various modifications and alternative forms, specific embodiments thereof are shown by way of example in the drawings and will herein be described in detail. However, it should be understood that there is no intention to limit the present invention to the particular embodiments disclosed, and on the contrary, the present invention is to cover all modifications, equivalents, and alternatives falling within the spirit and scope of the present invention. In the description of the drawings, the same drawing reference numerals will be understood to refer to the same elements, features, and structures.

Expressions such as “comprises,” “may comprise,” “includes,” and/or “may include,” when used herein, indicate the presence of a corresponding function, operation, or element disclosed herein, and do not preclude the presence of one or more additional functions, operations, or elements. It will be further understood that the terms “comprises,” “comprising,” “includes,” and/or “including,” when used herein, specify the presence of stated features, integers, steps, operations, elements, and/or components but do not preclude the presence or addition of one or more other features, integers, steps, operations, elements, components, and/or groups thereof.

In various embodiments of the present invention, expressions such as “or” include any one and all combinations of the words listed together. For example, “A or B” may include A, may include B, or may include both A and B.

It should be understood that, although the terms “first,” “second,” etc. may be used herein to modify various elements, these elements are not limited by these terms. For example, the expressions do not limit the order and/or importance of the corresponding elements. The expressions are only used to distinguish one element from another element. For example, a first user device and a second user device are both user devices and represent different user devices. For example, without departing from the scope of the present invention, a first element could be termed a second element, and, similarly, a second element could be termed a first element.

It will be understood that when an element is referred to as being “connected” or “coupled” to another element, although it can be directly connected or coupled to another element or intervening elements may be present, it should be understood that there may be a new element between the element and the other element. On the other hand, when an element is referred to as being “directly connected” or “directly coupled” to another element, it should be understood that there is no new element between the element and the other element.

The terminology used herein is for the purpose of describing particular embodiments only and is not intended to be limiting of the present invention. As used herein, the singular forms “a” and “an” are intended to include the plural forms as well, unless the context clearly indicates otherwise

Unless otherwise defined, all terms including technical and scientific terms used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, a system may represent at least one, or some, or all of: a configuration of devices, a method of operating the devices, a computer program for executing the method of operating the devices, and a medium in which the computer program is recorded.

Vehicles 11, 12, and 13 used throughout the specification include not only finished vehicles but also body in white (BIW) vehicles being assembled on a production line, and the movement of the vehicles 11, 12, and 13 refers to movement through a moving part, such as a conveyor, not by its own power.

FIG. 1 is a conceptual diagram schematically illustrating a production control system for a vehicle according to an embodiment of the present invention. The production control system for a vehicle according to the present embodiment includes tag devices 110, 120, and 130, tag readers 211 and 212, a code reader 220, and a server 300.

In addition, as shown in the drawings, the production control system may further include a transporter 400 disposed on a production line, a manufacturing execution system (MES) in a factory that interworks with the server 300, a controller, and the like.

As described above, the vehicles 11, 12, and 13 include not only a finished vehicle but also a BIW vehicle being assembled in a production line. The vehicles 11, 12, and 13 are transported along the production line for production. In this case, the vehicles 11, 12, and 13 are transported by the transporter 400 such as a conveyor.

In this case, the vehicles 11, 12, and 13 have identification codes. The identification code may be a vehicle identification number (VIN) or a code associated for identifying at least the same unique vehicle 11, 12, or 13.

The plurality of tag devices 110, 120, and 130 may each be attached to a corresponding one of the plurality of vehicles 11, 12, and 13 and move together with the plurality of vehicles 11, 12, and 13. For example, the tag devices 110, 120, and 130 are attached to the vehicle 11, 12, and 13 using a magnet or the like, and moved together as the vehicles 11, 12, and 13 are moved by the conveyor. After production completion, the tag devices 110, 120, and 130 may be removed from the vehicles 11, 12, and 13.

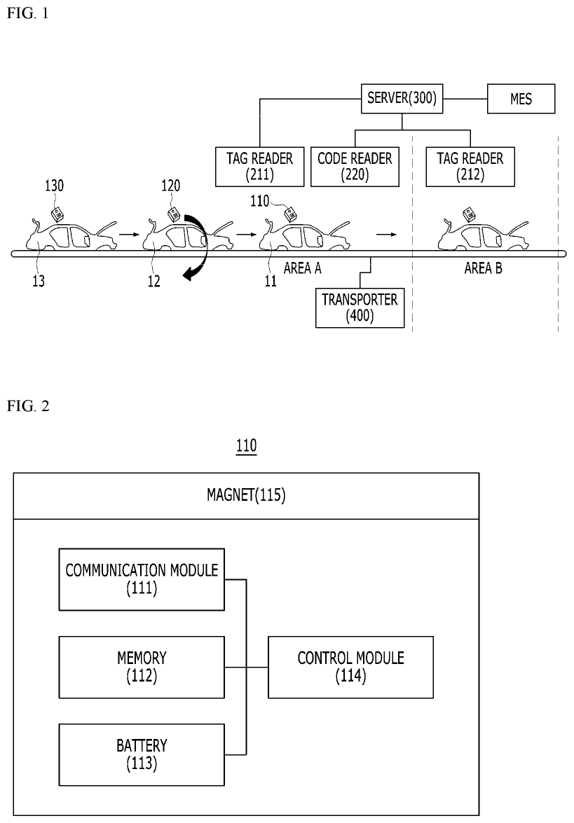

Each of the plurality of tag devices 110, 120, and 130 may have a tag ID. Referring to FIG. 2, the tag devices 110, 120, and 130 include a communication module 111, a memory 112, a battery 113, a control module 114, and a magnet 115. Additionally, the tag devices 110, 120, and 130 may further include an acceleration sensor (not shown) and a gyro sensor (not shown). Such a tag device 110 may be attached to the vehicle 11, 12, or 13 using a magnet formed on one surface of a housing thereof.

The communication module 111 may communicate with the tag readers 211 and 212. For example, the communication module 111 may be provided as an active device, such as an ultra-wideband (UWB) communication module, a radio frequency identification (RFID) communication module, or the like. The communication module 111 is driven by receiving power from the battery 113.

The memory 112 may store vehicle information and process information of the vehicle 11, 12, or 13 to which the tag device 110 is attached.

The battery 113 supplies power for operation of the tag device 110.

The control module 114 includes a micro controller unit (MCU) in which an algorithm for overall control of the tag device 110 is stored. The control module 114 may perform control to transmit the tag ID to the tag readers 211 and 212 through the communication module 111.

The acceleration sensor and the gyro sensor may measure an acceleration and an angular velocity, respectively, and transmit the measured acceleration and angular velocity to the control module 114.

Referring again to FIG. 1, the tag readers 211 and 212 may be disposed on the production line, and recognize the tag devices 110, 120, and 130. Additionally, the tag readers 211 and 212 may receive tag IDs from the tag devices 110, 120, and 130. In addition, the tag readers 211 and 212 may transmit vehicle information, process information, and the like of the vehicles 11, 12, and 13 to the tag devices 110, 120, and 130.

The tag readers 211 and 212 may be disposed on the production line as shown in the drawings. In particular, the tag readers 211 and 212 may be disposed adjacent to the transport path of the vehicles 11, 12, and 13. For example, the tag readers 211 and 212 may be provided in plural and respectively disposed at the beginning of each work process area along a production line as shown in the drawings. Alternatively, the tag readers 211 and 212 may include a plurality of antennas disposed to be spaced apart from each other along a production line.

Here, the tag readers 211 and 212 may include a first tag reader 211 and a second tag reader 212. The second tag reader 212 may encounter the vehicles 11, 12, and 13 that have passed through the first tag reader 211.

In more detail, the first tag reader 211 may be disposed in area A, which is a stage before a tag attaching process or a work process, such as a conformity verification process, and the second tag reader 212 may be disposed in area B of work processes. The tag reader 212 disposed in area B may be provided in plural and may respectively be disposed for each work process.

The tag readers 211 and 212 may recognize the tag devices 110, 120, and 130 and transmit a recognition result to the server 300. In this case, since the tag readers 211 and 212 are disposed in respective process areas (including a work process area and an attachment process area), the tag readers 211 and 212 may transmit whether the vehicle 11, 12, or 13 has entered each process to the server 300. Accordingly, the server 300 may track the positions of the vehicles 11, 12, and 13.

Meanwhile, the server 300 may track the current positions of the vehicle 11, 12, and 13 using the moving speed and the time from the point at which the tag reader 211 or 212 has recognized the tag device 110, 120, or 130. In more detail, the server 300 may track the tag devices 110, 120, and 130 using the transport distances of the vehicles 11, 12, and 13 on the production line. For example, when the vehicles 11, 12, and 13 are transported at a predetermined speed, the server 300 may calculate the moving speed and the moving time of the vehicles 11, 12, and 13 from the position and the time at which the code reader 220 or the tag readers 211 and 212 has recognized the tag device 110, 120, or 130 to identify the current positions of the vehicles 11, 12, and 13. By continuously calculating the above, the server 300 may identify the current positions of the tag devices 110, 120, and 130.

Furthermore, the transport distance of the vehicles 11, 12, and 13 may be calculated using the pitch, the transport time, and the speed of the transporter 400 (e.g., a conveyor) described above. In addition, the production control system according to the present invention may further include a line controller for controlling the transporter 400. The line controller may include a programmable logic controller (PLC) and may be connected to the server 300 to transmit and receive required information to and from the server 300.

The code reader 220 may be disposed on the production line. In more detail, the code reader 220 may be disposed in area A, but the position of the code reader 220 is not limited thereto.

The code reader 220 may recognize the identification codes of the vehicles 11, 12, and 13. In more detail, the code reader 220 may transmit at least one of a recognition result and the identification code of the vehicles 11, 12, and 13 to the server 300. For example, the code reader 220 may include at least one of an auto scanner and a handheld scanner. In addition, the code reader 220 reads body numbers attached to the vehicles 11, 12, and 13 (bodies) entering a process through the conveyor, and transmits the read body numbers to the server 300.

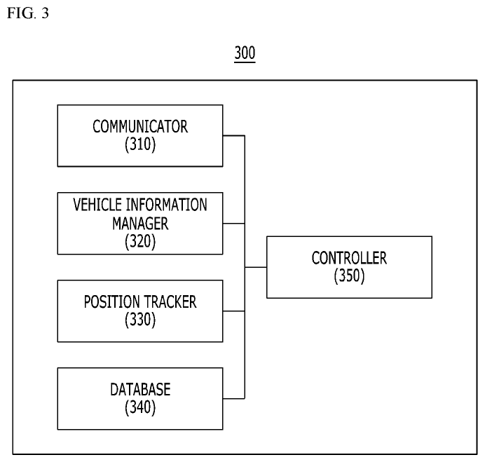

FIG. 3 is a block diagram schematically illustrating the server 300 of the production control system for the vehicle according to the embodiment of the present invention.

The server 300 may be included in each process equipment as middleware that interworks with an MES in a factory.

The server 300 determines information about the vehicles 11, 12, and 13 before input into the production line and whether the tag devices 110, 120, and 130 are attached to the vehicles 11, 12, and 13, and monitors the movement status of the tag devices 110, 120, and 130 input into a process. That is, the server 300 may identify the positions of the vehicles 11, 12, and 13, whether the vehicles 11, 12, and 13 are moving, whether the vehicles 11, 12, and 13 are being subjected to a work process, and the like using the tag devices 110, 120, and 130.

Referring to FIG. 3, the server 300 includes a communicator 310, a vehicle information manager 320, a position tracker 330, a database 340, and a controller 350.

The communicator 310 wirelessly communicates (etc. LTE, WiFi, 5G) with the tag device 110, 120, or 130 detected through the tag readers 211 and 212. Or The communicator 310 wirely communicates with the tag device 110, 120, or 130 detected through the tag readers 211 and 212.

The vehicle information manager 320 stores vehicle information received from the MES in the database 340. The database may include HDD, SSD, etc. In this case, the vehicle information manager 320 may map tag IDs of the tag devices 110, 120 and 130 that are sequentially attached to the vehicles 11, 12, and 13 loaded at regular intervals at the starting point of the conveyor and identification information and other various types of the corresponding vehicles 11, 12, and 13, and update a result of the mapping.

The position tracker 330 may detect the positions of the vehicles 11, 12, and 13 based on whether the plurality of tag readers 211 and 212 disposed along the production line have recognized the tag devices 110, 120, and 130 and the moving distance (i.e., the traveling distance of the conveyor). The position tracker 330 may detect position information (coordinates) of the tag devices 110, 120 and 130 according to the moving distance from coordinate information of the tag readers 211 and 212 at which the vehicles 11, 12 and 13 have been recognized. In this case, since the vehicles 11, 12, and 13 are moved in one direction by the conveyor installed along the production line, the position tracker 330 may track the positions of the vehicle 11, 12, and 13 based on the moving distance (that is, the traveling distance of the conveyor) from the points at which the vehicle 11, 12, and 13 have been recognized.

Alternatively, the position tracker 330 may store the coordinate system according to the conveyor traveling direction (path) of the vehicles 11, 12, and 13, and may detect position information (coordinates) of the tag devices 110, 120, and 130 according to the moving distance from the starting point at which the vehicles 11, 12, and 13 are loaded (see FIG. 1). In this case, since the vehicles 11, 12, and 13 are moved in one direction along the conveyor installed along the production line, the position tracker 330 may track the positions of the vehicles 11, 12, and 13 based on the moving distance (that is, the traveling distance of the conveyor) from the starting point at which the vehicles 11, 12, and 13 are loaded.

The database 340 stores various programs and data for managing tag information of the vehicles 11, 12, and 13 according to the embodiment of the present invention, and stores data generated according to the operation thereof.

The database 340 may store vehicle information of the vehicles 11, 12, and 13 received from the MES, and store vehicle information of a vehicle to which the tag device 110, 120 and 130 is attached.

The controller 350 is provided as a central processing unit (CPU) and controls the overall operation of each part for managing tag information of the vehicles 11, 12, and 13 in the production line. The controller 350 may include a microprocessor.

Meanwhile, the server 300 may receive the tag IDs of the tag devices 110, 120, and 130 from the tag readers 211 and 212 (e.g., the first tag reader 211), and receives the identification codes of the vehicles 11, 12, and 13 from the code reader 220, and map the tag IDs and the identification codes, and then track the positions of the vehicles 11 and 12 and perform work process control based on the tag IDs.

The server 300 may not be able to map the identification codes and the tag IDs for a predetermined reason. For example, the server 300 may not receive a tag ID from the tag readers 211 and 212. Alternatively, due to defects, falling, battery discharge, communication failures of the tag devices 110, 120, and 130, or the like, the tag reader 211 may misrecognize or not recognize the tag device 110, 120, and 130, and thus may transmit an abnormal tag ID or may not transmit a tag ID. In this case, the server 300 receives an abnormal tag ID or does not receive a tag ID, so mapping may fail.

That is, when the server 300 receives the identification code but does not receive the tag ID, mapping is not performed, and thus the vehicles 11, 12, and 13 may not be tracked and managed.

However, when mapping is not performed, the server 300 may generate a virtual tag having a virtual ID corresponding to the identification code that has not been mapped, map the identification code and the virtual ID, and track the virtual tag. Accordingly, even when the tag devices 110, 120, and 130 are unrecognized or misrecognized due to defects, falling thereof, the vehicles 11, 12, and 13 may be tracked and managed.

As a criterion for determining misrecognition or unrecognition, when the server 300 consecutively receives identification codes but non-consecutively receives tag IDs, a case of a tag device 110, 120, or 130 corresponding to an identification code present before a mapped identification code is determined as non-recognition or misrecognition. In addition, the server 300 may generate a virtual tag having a virtual ID corresponding to the identification code present before the mapped identification code and map the virtual tag and the identification code present before the mapped identification code. Here, the virtual ID and the virtual tag are used as different concepts, but may represent the same concept.

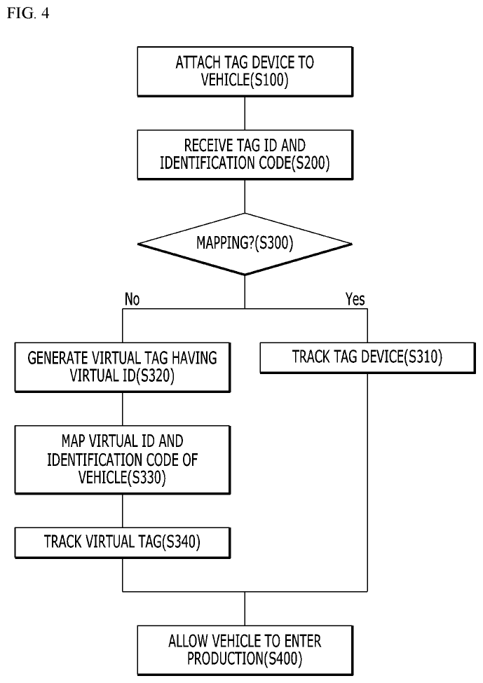

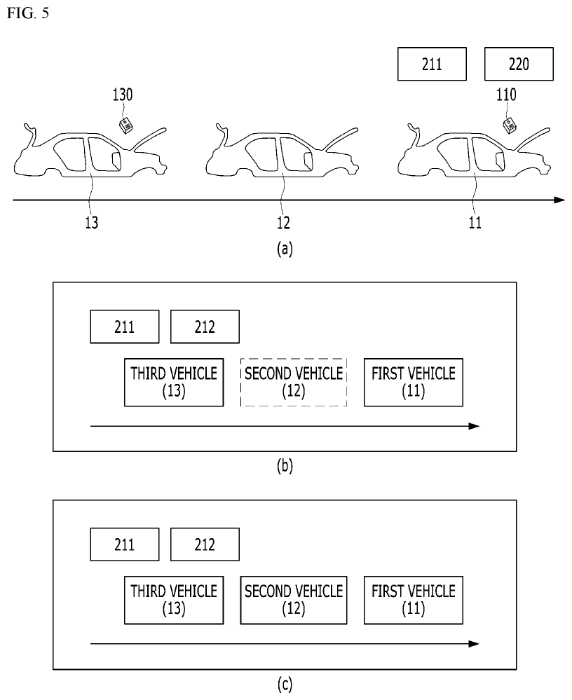

Operations performed by the server 300 will be described with reference to FIGS. 4 and 5 in more detail. Each process below may be repeated to correspond in number to the number of vehicles.

First, as shown in FIGS. 1 and 4, a tag attaching operation (S100) of attaching the tag devices 110, 120, and 130 to the vehicles 11, 12, and 13 having identification codes may be performed. In this case, the operator may manually attach the tag devices 110, 120, and 130 to the vehicles 11, 12, and 13. Alternatively, the tag devices 110, 120, and 130 may be automatically attached to the vehicles 11, 12, and 13.

The vehicles 11, 12, and 13 to which the tag devices 110, 120, and 130 are attached are transported to the code reader 220 and the tag reader 211 by the transporter 400. In addition, the code reader 220 and the tag reader 211 (the first tag reader) recognize the identification codes of the vehicles 11, 12 and 13 and the tag IDs of the tag devices 110, 120 and 130, respectively, and transmit results of the recognition to the server 300. The following description will be made based on the server 300.

A reception operation (S200) of receiving the identification code and the tag ID is performed. That is, the server 300 receives the identification code of one vehicle 11 from the code reader 220, and receives the tag ID of the tag device 110 attached to the one vehicle 11 from the tag reader 211.

A mapping operation (S300) of mapping the tag ID and the identification code is performed. That is, the server 300 maps the identification code of the one vehicle 11 and the tag ID of the tag device 110 attached to the one vehicle 11.

In this case, upon succeeding in mapping, the server 300 performs a tag device tracking operation S310 of tracking the tag devices 110, 120, and 130. That is, the server 300 tracks or manages the positions of the vehicles 11, 12, and 13 based on the tag IDs. Therefore, the server 300 may track the positions based on the transport speeds or transport distances of the vehicles 11, 12, and 13.

Meanwhile, upon failing to map a tag ID and an identification code in the mapping operation S300, the server 300 performs a virtual tag generation operation (S320) of generating a virtual tag having a virtual ID. That is, when the mapping fails, the server 300 generates a virtual ID and a virtual tag corresponding to an unmapped identification code.

Then, the server 300 performs a virtual mapping operation (S330) of mapping the unmapped identification code and the virtual ID. That is, the server 300 may map the unmapped identification code and the virtual ID.

In addition, the server 300 performs a virtual tracking operation (S340) of tracking the virtual tag. That is, the server 300 may map the unmapped identification code, which is not mapped to an actual tag ID, and the virtual ID, and track the position of the corresponding vehicle based on the virtual ID and the virtual tag and perform management.

When the vehicles 11, 12, and 13 are present, but the tag devices 110, 120, and 130 are unrecognized or misrecognized, the vehicles 11, 12, and 13 may be tracked and managed using the virtual tag.

Referring to FIG. 5, the criteria for determining unrecognition or misrecognition are described. FIG. 5A is a diagram schematically illustrating an actual process, and FIGS. 5B and 5C are diagrams schematically illustrating the concept of managing a virtual tag by the server 300, or a screen displayed to a user.

That is, the server 300 may track the positions of the tag devices 110, 120, and 130 and the virtual tag, and display the positions to the user. Accordingly, as shown in FIGS. 5B and 5C, the positions of the tag devices 110, 120, and 130 and the virtual tag indicate the positions of the vehicles 11, 12, and 13.

Because the plurality of vehicles 11, 12, and 13 consecutively enter a process, in the mapping operation S300, the code reader 220 or the tag reader 211 consecutively recognizes the identification codes or the tag IDs, and consecutively transmits the identification codes or the tag IDs to the server 300.

In this case, when the code reader 220 consecutively recognizes the identification codes but the tag reader 211 non-consecutively recognizes the tag IDs, the server 300 receives non-consecutive tag IDs.

In more detail, there are a first vehicle 11 having a first identification code, a second vehicle 12 having a second identification code, and a third vehicle 13 having a third identification code. There are a first tag device 110 attached to the first vehicle 11 and having a first tag ID, a second tag device 120 attached to the second vehicle 12 and having a second tag ID, and a third tag device 130 attached to the third vehicle 13 and having a third tag ID.

The first vehicle 11 to the third vehicle 13 consecutively enter the process in sequence, and the tag ID and the identification code are recognized by the tag reader 211 and the code reader 220, respectively.

In a normal case, the server 300 sequentially receives the first tag ID, the second tag ID, and the third tag ID from the tag reader 211, and almost simultaneously or within a predetermined time, receives the first identification code, the second identification code, and the third identification code from the code reader 220.

The server 300 sequentially maps the first tag ID, the second tag ID, and the third tag ID and the first identification code, the second identification code, and the third identification code, and performs tracking based on the tag IDs.

On the other hand, as shown in FIG. 5A, the second tag of the second vehicle 12 may be misrecognized or unrecognized due to battery discharge, communication failures, falling, incorrect position attachment of the second tag, and the like. In this case, it is assumed that the second tag device 120 is misrecognized or unrecognized.

The server 300 consecutively receives the first identification code, the second identification code, and the third identification code, but sequentially receives the first tag ID and the third tag ID.

In FIG. 5B, a situation in which the server 300 performs tracking is illustrated. In the mapping operation S300, the server 300 may be unable to map the second identification code, and may map the third identification code and the third tag ID. That is, although there is an actual second vehicle 12, the server 300 may determine that there is no second vehicle 12 because the second tag device 120 is unrecognized or misrecognized.

In order to prevent the above from happening, as shown in FIG. 5C, the server 300 generates a virtual tag corresponding to the received second identification code and tracks the virtual tag.

In more detail, the server 300 maps the first identification code and the first tag ID, does not map the second identification code, and maps the third identification code and the third tag ID. After or at the same time as the mapping of the third identification code and the third tag ID, the server 300 determines that the second tag device 120 is misrecognized or unrecognized because the second identification code is not mapped.

That is, the server 300 may, upon receiving the third tag ID and the third identification code according to the entry of the third vehicle 13 (the following vehicle) into a process, determine the second vehicle 12, which is a preceding vehicle, as a mapping failure.

Then, the server 300 generates a virtual tag corresponding to the second identification code. In this case, the virtual tag includes a virtual ID.

Then, the server 300 maps the virtual ID to the second identification code and performs tracking based on the virtual ID. That is, the server 300 tracks the positions of the vehicles 11, 12, and 13 based on the virtual tag.

Therefore, as shown in FIG. 5C, the server 300 may map, track, and manage all vehicles 11, 12, and 13 such that a vehicle 11, 12, or 13 is prevented from being skipped due to being unmapped.

Meanwhile, the server 300 may track the virtual tag using the position of the tag device 110, 120, or 130 adjacent to the virtual tag.

In more detail, since the vehicles 11, 12, and 13 are transported by the conveyor at regular intervals, the intervals between the first vehicle 11, the second vehicle 12, and the third vehicle 13 are approximately the same.

Accordingly, the server 300 may identify and track the virtual tag using the interval from the position of the first tag device 110 attached to the first vehicle 11 or the position of the third tag device 130 attached to the third vehicle 13.

Meanwhile, according to another embodiment of the present invention, the server 300 may determine whether mapping has been successful based on the reception time of the identification code and the tag ID. The first identification code, the second identification code, and the third identification code are consecutively received, but the first tag ID and the third tag ID are sequentially received. A gap occurs between a time of receiving the first tag ID and a time of receiving the third tag ID.

For example, the server 300 may, upon failing to receive the second tag ID within a predetermined time after receiving the second identification code, determine that mapping has failed, generate a virtual tag, and map the virtual ID to the second identification code.

Thereafter, the vehicles 11, 12, and 13 are transported to the work process area to complete each work process with the equipment.

The above-described processes may be repeated.

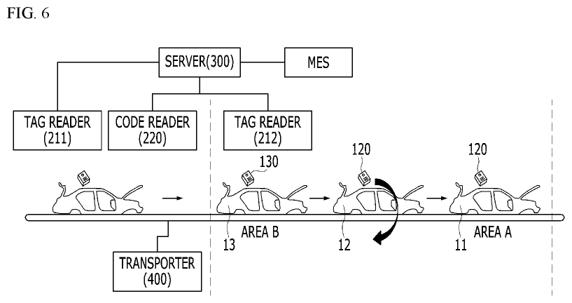

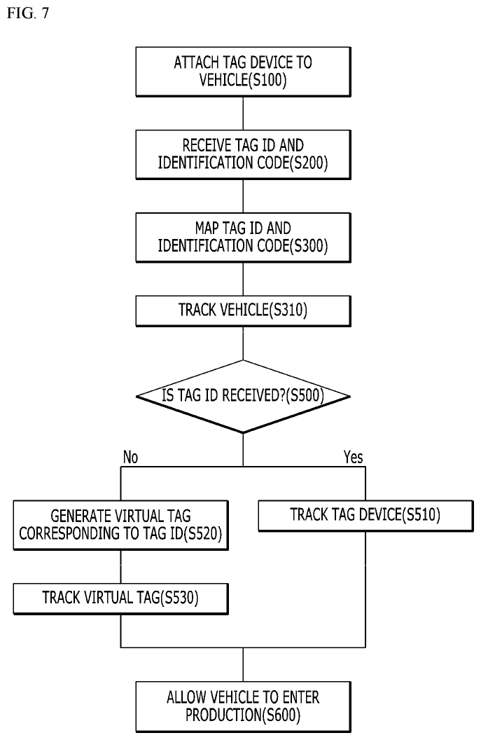

FIGS. 6 and 7 are diagrams schematically illustrating a production control system and method for a vehicle according to another embodiment of the present invention. In the description of the production control system and method for the vehicle according to the present embodiment, the same description as above will be omitted.

During a work process (in area B), a tag device attached to the vehicle 11, 12, or 13 may not be precisely recognized by the second tag reader 212 due to battery discharge, communication failures, falling, malfunctions thereof or the like, which is considered misrecognition or unrecognition.

In this case, the vehicle 12 is determined as not actually existing or not moving, and thus vehicle management is not ensured.

In order to prevent the above, the server 300 may, upon a misrecognition or unrecognition in the second tag reader 212, generate a virtual tag corresponding to the tag ID or identification code and track the virtual tag. When generating the virtual tag corresponding to the identification code, the virtual tag may include a virtual ID, and the virtual ID may be substituted for the tag ID.

In more detail, as shown in FIG. 6, the server 300 maps the identification code and the tag ID, and tracks the positions of the vehicles 11, 12, and 13 or perform management based on the tag IDs or the tag devices 110, 120, and 130, which is the same as in the production control system and method for the vehicle according to the above-described embodiment. In addition, the server 300 performs an entry operation of allowing the vehicles 11, 12, and 13 to enter the work process.

The tag reader 212 is positioned at the beginning of each work process area. For the sake of convenience of description, a tag reader present in the work process area is referred to as a second tag reader 212.

The second tag reader 212 performs a recognition operation of recognizing the tag devices 110, 120, and 130, and transmitting results of the recognition to the server 300.

The server 300 performs a tag reception operation (S500) of receiving the tag IDs of the tag devices 110, 120, and 130 from the second tag reader 212, and determines whether the vehicles have entered the process based on the received tag IDs.

The server 300, upon receiving the tag IDs from the second tag reader 212, performs tracking and work management based on the tag IDs or the tag devices 110, 120, and 130 (S510).

However, due to the various reasons described above, a misrecognition or unrecognition may occur in the second tag reader 212. That is, the server 300 may not receive the tag ID from the second tag reader 212 or may not receive accurate information even when receiving the tag ID.

In this case, the server 300 performs a virtual tag generation operation S520 of generating a virtual tag corresponding to the tag ID that has not been received. Since tag IDs are stored in advance according to the sequence of the vehicles 11, 12, and 13, the server 300 may map the tag ID that has not been received to the virtual tag.

In addition, the server 300 may perform a virtual tag tracking operation (S530) of tracking the virtual tag, and manage work status and the like.

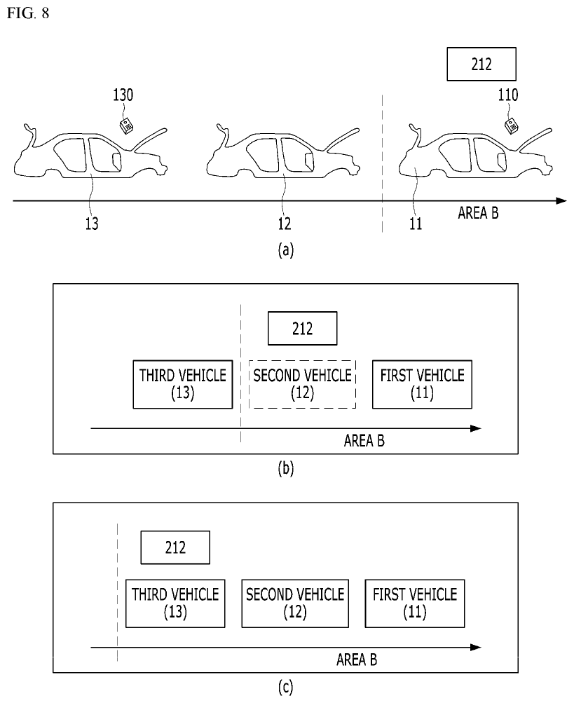

The tag ID reception operation will be described in more detail with reference to FIG. 8.

Referring to FIG. 8A, the vehicles 11, 12, and 13 sequentially enter the work process area (area B), and the second tag reader 212 scans the tag IDs of the tag device 110, 120, and 130 attached to the sequentially entering vehicles 11, 12, and 13 and transmits the tag IDs to the server 300.

For example, the second tag reader 212 sequentially scans the first tag device 110, the second tag device 120, and the third tag device 130 and transmits the respective tag IDs to the server 300.

When the second tag device 120 attached to the second vehicle 12 is misrecognized or unrecognized for the above-described reason, the second tag reader 212 transmits the first tag ID, skips transmitting the second tag ID and transmits the third tag ID to the server 300.

As shown in FIGS. 8B and 8C, the server 300 may, upon receiving the first tag ID of the first tag device 110, which is the preceding tag device, from the second tag reader 212, but failing to receive the second tag ID of the second tag device 120, which is the following tag device, within a predetermined time from the reception of the first tag ID, determine that an unrecognition or misrecognition has occurred, and generate a virtual tag and track the virtual tag. Here, the predetermined time may be determined by the transport speed of the vehicles 11, 12, and 13.

In this case, the predetermined time may be calculated using the transport speed of the vehicle and the like.

Alternatively, the server 300 may, upon receiving the first tag ID of the first tag device 110, which is the preceding tag device, from the second tag reader 212, but failing to receive the second tag ID of the second tag device 120, which is the following tag, and receiving the third tag ID of the third tag device 130, which is the next following tag device, determine the second tag device 120 as being unrecognized or misrecognized, and generate a virtual tag and track the generated virtual tag.

As is apparent from the above, the production control system for the vehicle and the method thereof can normally perform tracking even when a tag device is not attached to a vehicle or is defective.

The scope of the present application is not limited to the above-described effects.

Although embodiments of the present invention have been described with reference to the accompanying drawings, this is for illustrative purposes, and a person of ordinary skill in the art should appreciate that various modifications, equivalents, and other embodiments are possible without departing from the scope and sprit of the present invention. Therefore, the scope of the present invention is defined by the appended claims of the present invention.

What is claimed is:

1. A production control system for a vehicle, comprising:
a plurality of tag devices each attached to a corresponding one of a plurality of vehicles each having an identification code and moving along a production line together with the plurality of vehicles to identify positions of the plurality of vehicles, the plurality of tag devices each having a tag ID;
a tag reader disposed on the production line and configured to recognize the tag ID of the tag device;
a code reader disposed on the production line and configured to recognize the identification code of the vehicle; and
a server configured to receive the identification code of the vehicle from the code reader and receive the tag ID of the tag device from the tag reader and map the identification code and the tag ID, and upon a failure to map the identification code and the tag ID for a predetermined reason, generate a virtual tag having a virtual ID, map the virtual ID and the identification code, and track the virtual tag.

2. The production control system of claim 1, wherein the server is configured to, upon consecutively receiving the identification codes but non-consecutively receiving the tag IDs, generate the virtual tag having the virtual ID corresponding to an identification code present before the mapped identification code and map the generated virtual tag and the identification code.

3. A production control system for a vehicle, comprising:
a plurality of tag devices each attached to a corresponding one of a plurality of vehicles each having an identification code and moving along a production line together with the plurality of vehicles to identify positions of the plurality of vehicles, the plurality of tag devices each having a tag ID;
a first tag reader disposed on the production line and configured to recognize the tag ID of the tag device;
a second tag reader disposed on the production line and configured to recognize the tag ID of the tag device that has been recognized by the first tag reader;
a code reader disposed on the production line and configured to recognize the identification code of the vehicle recognized by the first tag reader; and
a server configured to receive the identification code of the vehicle from the code reader and receive the tag ID of the tag device from the first tag reader and map the identification code and the tag ID, and upon occurrence of a misrecognition of the mapped tag device in the second tag reader, generate a virtual tag corresponding to the tag ID or the identification code and track the virtual tag.

4. The production control system of claim 3, wherein the server is configured to determine a case of a preceding tag device being recognized by the second tag reader but a following tag device not being recognized within a predetermined time or poorly recognized by the second tag reader as a misrecognition.

5. The production control system of claim 1, wherein the server is configured to track the virtual tag based on a position of the tag device adjacent to the virtual tag.

6. The production control system of claim 1, wherein the server is configured to display positions of the tag device and the virtual tag.

7. The production control system of claim 2, wherein the server is configured to track the virtual tag based on a position of the tag device adjacent to the virtual tag.

8. The production control system of claim 2, wherein the server is configured to display positions of the tag device and the virtual tag.

9. A production control method of controlling the production control system for a vehicle according to claim 1, the production control method comprising:
a reception operation of receiving the tag ID and the identification code;
a mapping operation of mapping the tag ID and the identification code;
a virtual tag generation operation of generating, upon a mapping failure, a virtual tag having a virtual ID corresponding to an identification code for which the mapping has failed;
a virtual mapping operation of mapping the identification code, for which the mapping has failed, and the virtual ID; and
a virtual tracking operation of tracking the virtual tag.

10. The production control method of claim 9, wherein the mapping operation comprises, upon consecutively receiving the identification codes but non-consecutively receiving the tag IDs corresponding to the identification codes, determining an identification code corresponding to a missing tag ID as a mapping failure.

11. A production control method of controlling the production control system for the vehicle according to claim 3, the production control method comprising:
a tag ID receiving operation of receiving, by the second tag reader, a tag ID of the tag device;
generating, upon a misrecognition or non-recognition in the tag ID reception operation, the virtual tag corresponding to the tag ID or the identification code; and
tracking the virtual tag.

12. The production control method of claim 11, further comprising determining a case of a tag ID of a preceding tag device being received from the second tag reader but a tag ID of a following tag device not being received within a predetermined time or erroneously received as a non-recognition or a misrecognition.
